(19) United States
(12) Patent Application Publication
(10) Pub. No.: US 2022/0134914 A1
(43) Pub. Date: May 5, 2022

(54) METHOD AND APPARATUS FOR MUSIC RECOMMENDATION STREAMING SERVICE USING USER SITUATION SENTIMENT ANALYSIS BASED ON ARTIFICIAL INTELLIGENCE

(71) Applicant: inDJ, Gwangju (KR)

(72) Inventor: Woo Ju JUNG, Seoul (KR)

(21) Appl. No.: 17/358,880

(22) Filed: Jun. 25, 2021

(30) Foreign Application Priority Data
Oct. 30, 2020 (KR) 10-2020-0142751
Oct. 30, 2020 (KR) 10-2020-0142753

(51) Int. Cl. B60N 2/26; B60N 2/00; B60N 2/02; B60R 11/02; G06N 20/00

(52) U.S. Cl. CPC B60N 2/26; B60N 2/002; B60R 2011/0012; B60R 11/0217; G06N 20/00; B60N 2/0244

(57) ABSTRACT

Provided are a method and an apparatus for a music recommendation streaming service using user situation and sentiment analysis based on artificial intelligence capable of recommending a content suitable for a user getting on a moving means using sensor information.

### CROSS-REFERENCE TO RELATED APPLICATIONS

This application claims priority to and the benefit of Korean Patent Application No. 10-2020-0142751 filed in the Korean Intellectual Property Office on Oct. 30, 2070, Korean Patent Application No. 10-2020-0142753 filed in the Korean Intellectual Property Office on Oct. 30, 2020, the entire contents of which are incorporated herein by reference.

### TECHNICAL FIELD

The present invention relates to a method and an apparatus for music recommendation based on user situation and sentiment analysis in a moving means using artificial intelligence.

### BACKGROUND ART

Recently, with the improvement of the level of living, while the vehicle culture is routine, due to long distance driving such as travel, traffic jams, or the like, the time to stay inside the vehicle is gradually increasing. As a result, various convenient facilities and services have been provided inside the vehicle for the convenience of passengers staying inside the vehicle for a long time.

Typically, there is a telematics service among these convenient services. The telematics is a term in which telecommunication and informatics are combined, and defined as a next-generation information providing service for automobiles through the combination of the IT industry in which wireless communication, automobiles, terminals, contents, etc. are organically associated with each other and the automobile industry.

The telematics service may provide various services such as transportation and driving information, emergency context information, remote vehicle diagnostic services and internet, e-mail, life information, entertainment, etc., through terminals in the vehicle by using wireless communication technology and global positioning system (GPS) technology. Further, as contents that may be consumed during the driving are various, the telematics service has been extended to an integrated vehicle platform, such as providing contents such as music and radio during driving.

In Korean Patent Publication No. 10-2013-0036488 (published on Apr. 12, 2013) “Device for recommending sound source based on vehicle drive conditions”, there is provided a technology of automatically recommending and reproducing a preferred sound source according to vehicle drive conditions.

### SUMMARY OF THE INVENTION

The present invention has been made in an effort to recommend an appropriate content to a user getting on a moving means using sensor information.

Other objects of the present invention, which are not explicitly described, may be additionally considered within the scope which may be easily deduced from the following detailed description and the effects thereof.

An exemplary embodiment of the present invention provides a method for a content recommendation streaming service of a moving means mounted with sensors, including the steps of: measuring the weight of a passenger; determining information on the passenger according to a result of comparing the weight of the passenger with predetermined data; and providing a content by using the information on the passenger.

The determining of the passenger information may determine the arrangement of seats, the presence of passengers, the number of passengers, and whether some of the passengers are infants.

The determining of the passenger information may check whether the infants board by considering a seat position where a car seat is installed and a weight change of the car seat.

The providing of the content may receive the feedback of the crying sound of the infants to recommend a content or control a volume of a speaker corresponding to the position of the car seat using artificial intelligence.

The providing of the content may check the visit of a rest area through the sensor and recommend travel music that considers the preference for the remaining passengers during the visit of the rest area using artificial intelligence.

The providing of the content may check the scenery through the sensor, sense actions in which some passengers temporarily get off or lower a window while the moving means is temporarily stopped in order for the passengers to see the scenery, and change a music mode or control the volume according to the scenery using artificial intelligence.

Another exemplary embodiment of the present invention provides a moving means, including: a sensor which is installed in a seat to measure the weight of a passenger; a processing unit which determines information on the passenger according to a result of comparing the weight of the passenger with predetermined data; and an output unit which provides a content by using the information on the passenger.

The processing unit may determine the arrangement of seats, the presence of passengers, the number of passengers, and whether some of the passengers are infants.

The processing unit may check whether the infants board by considering a seat position where a car seat is installed and a weight change of the car seat.

The moving means may include a voice sensing device that receives the feedback of the crying sound of the infants, and the output unit may recommend a content or control a volume of a speaker corresponding to the position of the car seat using artificial intelligence based on the crying sound.

The moving means may include a navigation to search a peripheral environment of the moving, means, the processing, unit may check the visit of a rest area through the position of the moving means, the sensor may determine the get-off of some passengers, and the output unit may recommend travel music that considers the preference for the remaining passengers during the visit of the rest area using artificial intelligence.

The sensor may include an image sensor which is installed inside or outside of the moving means to photograph the internal or external sides of the moving means, the image sensor may check the scenery, the processing unit may sense actions in which sonic passengers temporarily get off or lower a window while the moving means is temporarily stopped in order for the passengers to see the scenery, and the output unit may output music changed according to the scenery or control the volume using artificial intelligence.

As described above, according to the exemplary embodiments of the present invention, it is possible to recommend an appropriate content to a user getting, on a moving means using sensor information.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIGS. 1 to 3 are diagrams illustrating a moving means according to an exemplary embodiment of the present invention.

FIG. 4 is a diagram illustrating a user situation and sentiment analysis model applied to the moving means according to an exemplary embodiment of the present invention.

FIGS. 5 to 6 are diagrams illustrating a content recommendation device implemented in the moving means according to an exemplary embodiment of the present invention.

FIG. 7 is a flowchart illustrating a method for a content recommendation streaming service according to another exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings.

Hereinafter, in describing the present invention, a detailed explanation of known technologies associated with the present invention, which is apparent to those skilled in the art may be omitted to avoid unnecessarily obscuring the subject matter of the present invention and some exemplary embodiments of the present invention will be described in detail through illustrative drawings.

Since a preferred content varies many times a day by a driving situation, and user situation and sentiment due to characteristics of users of Internet of Things and smart cars, there is a need for a ‘situation-based recommendation’ method of analyzing a user situation and recommending a content according to the situation.

A real-time analysis technology research (HW) is required by developing an In-Memory-based Complex Stream Processing technology of providing a user customized content in various environments, constructing interfaces that may be linked with a mobile platform (SW), and processing and analyzing real-time situation streaming data of a connected vehicle.

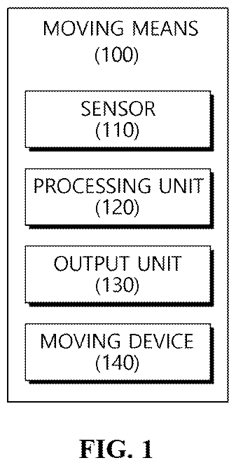

FIGS. 1 to 3 are diagrams illustrating a moving means according to an exemplary embodiment of the present invention.

A technology based on an apparatus and a method for content recommendation according to a vehicle situation applied to a moving means includes 1) understanding, a user's profile, 2) determination of point of interest (POI) and determination of main residence and real-time situation through sensor data, 3) situation determination based on real-time dynamic sensing, and 4) providing a content suitable for a user preference and a situation recognition result.

The technology understands a current situation of the user by using user situation information collected through various sensor information of a connected car and a mobile terminal device (Context Awareness) and infers and proposes music, broadcast, channels etc. which the user wants to hear in the current situation and sentiment. The technology provides a suitable content for the user by enhancing the accuracy of recommendation through Smart devices and vehicle sensors, and minimizing the unequal distribution of recommendation such as long tail and filter bubble effects.

Referring to FIG. 1, a moving means 100 includes a sensor 110 which is installed in a seat to measure the weight of a passenger, a processing unit 120 which determines information on the passenger according to a result it comparing the weight of the passenger with predetermined data, and an output unit 130 which provides a content by using the information on the passenger. The moving means 100 includes a moving device 140 implemented to move the moving means 100. The moving device 140 is a device that may be driven through wheels, rails, and the like.

The processing unit 120 may determine the arrangement of seats, the presence of passengers, the number of passengers, and whether some of the passengers are infants. The sensor 110 installed for each seat senses a weight change of the seat, and the processing unit 120 may analyze the weight change of each seat to deter mine passenger information.

The processing unit 120 may check whether the infants board by considering a seat position where a car seat is installed and a weight change of the car seat. The processing unit 120 may configure reference data by storing statistically weight changes measured for a predetermined period and check whether the infants board by using a difference compared with the reference data.

The moving means 100 may include a voice sensing device that receives the feedback of the crying sound of the infants. The output unit 130 may recommend a content or control a volume of a speaker corresponding to the position of the car seat based on the crying sound using artificial intelligence.

The moving means 100 may include a navigation to search a peripheral environment of the moving means. The processing unit 120 checks the visit of a rest area through the position of the moving means, the sensor 110 determines the get-off of some passengers, and the output unit 130 may recommend travel music that considers the preference for the remaining passengers during the visit of the rest area using artificial intelligence.

The sensor 110 may include an image sensor which is installed inside or outside of the moving means to photograph the internal or external sides of the moving means. The image sensor checks the scenery, the processing unit 120 senses actions in which some passengers temporarily get off or lower a window while the moving means is temporarily stopped in order for the passengers to see the scenery, and the output unit 130 may output music changed or control the volume according to the scenery using artificial intelligence.

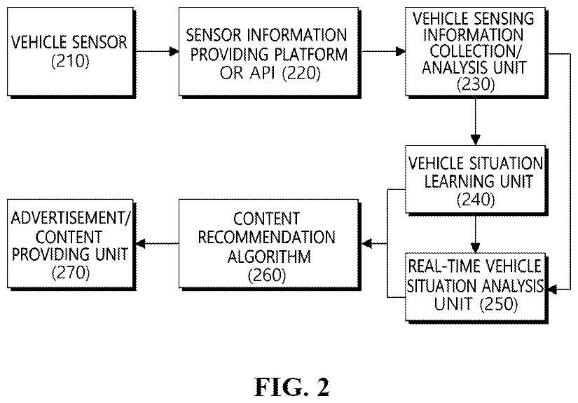

Referring to FIG. 2, the content recommendation system includes a plurality of vehicle sensors 210, a sensor information providing platform 220, a vehicle sensing information collection/analysis unit 230, a vehicle situation learning unit 240, a real-time vehicle situation analysis unit 250, a content recommendation algorithm 260, and an advertisement/content providing unit 270.

The plurality of vehicle sensor 210 collects the situation of the vehicle and transmits the collected vehicle situation to the sensor information providing platform 220. The plurality of vehicle sensors 210 may collect passenger information from, for example, a weight sensor counted on the seat of the vehicle. The weight sensor is counted on the seats provided in the vehicle, respectively, and senses the body weight of the seated passenger to provide the sensing value to the sensor information providing platform 220.

Information sensed in the plurality of vehicle sensors 210 may include sensing. information by external factors such as weather, temperature, humidity, luminance, time zone, running road, and traffic situation, and sensing information by internal factors such as vehicle speed, before/after drive start, stop, parking, restart, and vehicle mode.

The sensor information providing platform 220 may transmit the situation information of the vehicle received from the plurality of vehicle sensors 210 to the vehicle sensing information collection/analysis unit 230 in an unprocessed raw data state or generate the corresponding passenger type information according to a predetermined passenger type determination reference value to transmit the generated passenger type information to the vehicle sensing information collection/analysis unit 230.

By comparing the weight of the passenger received from the plurality of vehicle sensors 210 with the predetermined weight, it is possible to determine the presence or the passenger and the gender of the passenger. Therefore, the vehicle sensing information collection/analysis unit 230 may determine a mode as a date mode when passengers had get on a driver seat and a passenger seat and the gender of the passengers is different, a solo mode when a person gets only on the driver seat, and a family mode when persons get on rear seats as well as the diver seat and the passenger seat. The vehicle sensing information collection/analysis unit 230 may transmit the determined passenger type information to the vehicle situation learning unit 240 and the real-time vehicle situation analysis unit 250. The vehicle situation learning unit 240 learns the vehicle situation based on the information received from the vehicle sensing information collection/analysis unit 230 and transmits the learned vehicle situation to the real-time advertisement/content providing unit 770.

The advertisement/content providing unit 270 may receive the vehicle situation from the vehicle situation learning unit 240 to generate recommendation content information and provide the corresponding content.

The content may include videos such as music, photographs, drama, movies, and moving pictures such as music videos. The recommendation content information may include a content file or include an address of a streaming server providing the corresponding content. Thus, the advertisement/content providing unit 270 may store and reproduce the content information, or provide the content information by a streaming service method by accessing the streaming server.

The vehicle sensing information collection/analysis unit 230 may receive vehicle situation information in an unprocessed raw data state from the sensor information providing platform 220, or may receive vehicle situation type information. The vehicle sensing information collection/analysis unit 230 receiving the vehicle situation information in the raw data state determines a vehicle situation type by comparing the received vehicle situation information in the raw data state with a predetermined vehicle situation reference value. As a result, the advertisement/content providing unit 270 selects the recommendation content information based on the pre-learned model according to the vehicle situation type and the vehicle situation to provide the corresponding content.

The real-time vehicle situation analysis unit 250 determines occurrence of an event based on the vehicle situation received from the vehicle sensing information collection analysis unit 230 or the vehicle situation learning unit 240. During the occurrence of the event, the advertisement/content providing unit 270 may immediately stop the existing content which has been provided and immediately provide a content according to the event occurrence received from the real-time vehicle situation analysis unit 250.

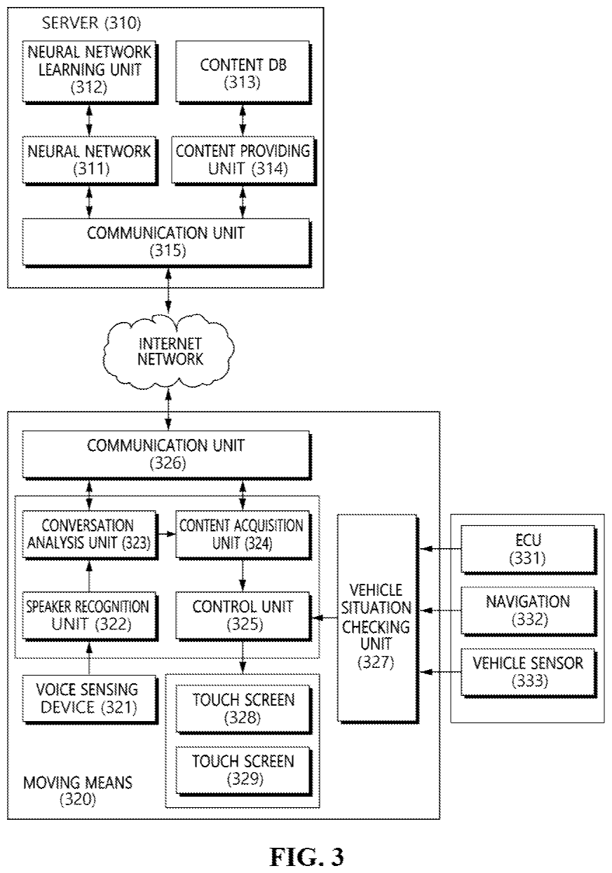

Referring to FIG. 3, the moving means 320 may further include a vehicle situation checking unit 180 interlocked with an electronic control unit (ECU) 331, a navigation 332, a vehicle sensor 333, etc. included in the vehicle, in addition to a multimedia reproduction device 110, a voice sensing device 321, a speaker recognition unit 322, a conversation analysis unit 323, a content acquisition unit 324, a control unit 325, and a communication unit 326.

At this time, the ECU 331 may acquire and provide all vehicle electronic control values, and particularly, may provide information on a vehicle speed, a vehicle movement direction, and the like. The navigation 332 may provide information on a current vehicle position, a real-time traffic situation, and the like, and the vehicle sensor 333 may provide information on a vehicle internal/external environment.

The vehicle driving situation may be divided into a driving caution situation, a vehicle position guidance situation, a traffic guidance situation, a weather guidance situation, and the like.

Therefore, the vehicle situation checking unit 327 pre-defines a vehicle driving situation corresponding to the vehicle control value, the vehicle position, the real-time traffic situation, and the weather information acquired by the ECU 331, the navigation 332, and the vehicle sensor 333. In addition, the vehicle situation checking unit 327 analyzes the information provided by the ECU 331, the navigation 332, and the vehicle sensor 333 based thereon to determine a current vehicle driving situation and notify the determined vehicle driving situation to the control unit 325.

When the vehicle driving situation is a predetermined vehicle driving situation, the control unit 325 may more safely assist the user driving by temporarily stopping the content reproduction or providing driver guidance information corresponding to the current driving situation instead of the content.

For example, when the driving caution situation in which the vehicle speed is abnormally increased or rapidly rotated occurs, the user may more focus on driving by pausing the content reproduction. When the vehicle position is adjacent to a pre-registered place, information of guiding the corresponding place is provided instead of the content, when the occurrence of a vehicle accident is checked in front of the vehicle, information of guiding the accident occurrence is provided instead of the content, and when engine overheat is detected, information of guiding that the engine has overheated may be provided instead of the content.

When many persons get on the vehicle and then start to talk, the moving means senses the voices of a plurality of passengers through the installed voice sensing device 321 and starts to identify and recognize the voice of each of the plurality of passengers through the speaker recognition unit 322.

The moving means 320 textualizes and stores the voice recognition result for each of the plurality of vehicle passengers and determines and tracks the conversation content between the vehicle passengers based thereon.

The moving means 320 often checks whether a content search event occurs. At this time, the content search event may occur when repeatedly occurring at predetermined time intervals, when a voice including predetermined words or sentences (e.g., ‘content search’) is inputted, or when a button mapped with a content search function is manually operated, and of course, it is natural that the content search event occurrence condition may be adjusted if necessary.

If the content search event occurrence is checked, the moving means extracts plurality of valid words by performing morphological analysis and stopword processing for a document textualizing the conversation content up to now.

After keywords are selected by considering an occurrence frequency of each word, the number of vehicle passengers commonly mentioning each word, etc., the moving means is connected to the server 310 to infer what a conversation subject corresponding to the corresponding words is based on a learned neural network 311. The neural network 311 is learned based on pre-learned data through a neural network learning unit 312.

When the keywords are selected, a weight of each of the vehicle passengers mentioning each word, a social interest in each word, etc. may be further considered. A more significant conversation subject search operation may be performed by further considering factors such as a personal configuration of vehicle passengers and a social atmosphere in addition to the conversation content.

To acquire the weight of each vehicle passenger, the moving means configures a weight input screen to provide the screen through a touch screen 328, so that one of the vehicle passengers may configure a weight of each vehicle passenger through this. In addition, the social interest for each word may be determined by a real-time search word ranking, the number of search results, or the like in web portals such as Navel, and Daum.

In other words, by considering that metadata included in the content basically includes information about content types and genres, when the type of content is an audio, only a speaker may be activated, in the case of pictures or text, only a touch screen may be activated, and in the case of moving pictures, both the speaker and the touch screen may be activated. Further, an audio environment setting value and a touch screen setting value are actively varied according to the genre of the content, so that it is possible to construct a multimedia regeneration environment optimized for the content.

An optimal content may be automatically searched and provided based on the conversation contents of a plurality of people getting on the vehicle. The communication unit 315 of the server and the communication unit 326 of the moving means performs data communication. The content providing unit 314 searches and selects the content stored in a content DB 313 to provide a suitable content.

Since the content providing environment is the vehicle, the driver's concentration needs not to be degraded by the content reproduction. Accordingly, according to the present invention, it is possible to check the vehicle driving environment through the linkage with the vehicle device and control a content reproduction operation by further considering the checked vehicle driving environment.

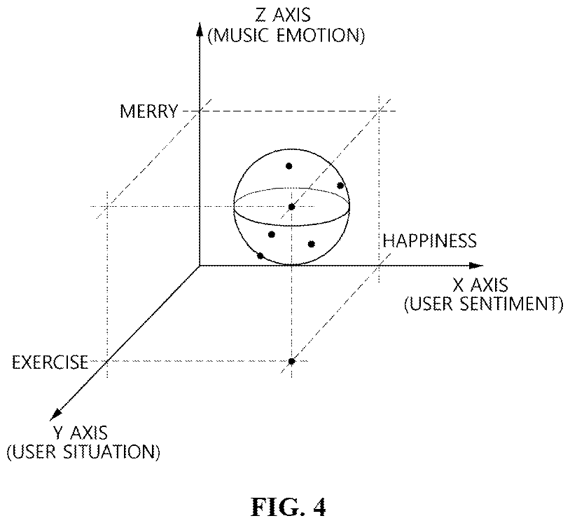

FIG. 4 is a diagram illustrating a user situation and sentiment analysis model applied to the moving means according to an exemplary embodiment of the present invention.

When there is a music recommendation request from the content recommendation device while the preferred music profile is generated, the server receives the user data collected by the content recommendation device, and derives user situation and user sentiment from user data.

Thereafter, the server laps the derived user situation and user sentiment on a three-dimensional graph of the preferred music profile to derive reference music m having music emotion corresponding to the derived user situation and user sentiment on the three-dimensional mph of the preferred music profile. Similarity is calculated by a difference between numeric values of arousal and valence of the music emotion of the derived reference music in, and at least one music having the similarity within a predetermined range M is selected as recommendation music (at least one of m, a, b, c, d, and e). As a result, the server may provide the derived recommendation music (at least one of m, a, b, c, d, and e) to the content recommendation device.

The content recommendation device may derive the user sentiment based on the received user data.

The content recommended device determiner whether the music is user's preferred music based on the received user data, and maps the music emotion, the user situation, and the user sentiment on the three-dimensional graph to configure the preferred music profile when the music is the user's preferred music.

The content recommendation device derives the user situation at the time of the user's music recommendation request, derives the user sentiment, and then maps the derived user situation and user sentiment on the three-dimensional graph of the preferred music profile to derive recommendation music (in, a, b, c, d, and e) within a predetermined range M on the three-dimensional graph of the preferred music profile. Then, the derived recommendation music (at least one of m, a, b, c, d, and e is transmitted through the communication unit.

When it is determined to prefer the corresponding music, the content recommendation device derives the music emotion which is the emotion expressed by the music reproduced by the user device from music emotion data of the user data.

The user device may mean the moving means and may include a device worn on a user getting on the moving means.

Here, the music emotion data includes at least one of a plurality of parameters derived from the characteristics of a time domain signal and a frequency domain signal of the music. The plurality of parameters may be exemplified, for example, tone, articulation, composition, tempo, and the like. At this time, the arousal indicating the emotional intensity and the valence expressing the degree of positive and negative are derived from the music emotion data as normalized numeric values. For example, it is possible to determine the arousal according to the speed of the tempo. That is, as the tempo is fast, it is possible to derive the numeric value because the arousal is high.

Further, for example, according to the characteristics of the frequency domain of the music, the tone may be derived, and the tone may be normalized and numerated from the positive degree to the negative degree of the emotion depending on the frequency size. Thus, the numeric value of the valence may be derived from the tone derived according to the characteristics 4 the frequency domain 4 the music. In addition, the music emotion is determined according to the numeric values of the arousal and the valence. Each of the music emotion has a range of predetermined numeric values of the arousal and the valence. For example, the music emotion may include ‘calm’, ‘excited’ happy' ‘pleased’, ‘relaxed’, ‘peaceful’, ‘sleepy’, ‘sad’, ‘bored’, ‘nervous’ and ‘angry’ in a similar order.

Next, the user situation which is a situation experienced by the user at the time of listening to the music is derived by using user situation data of the user data. The user environment data includes at least one of position information of the user device, inertia information of the user device, weather information of the position of the user device, and time information. The user situation is derived based on the user environment data. For example, when the time information is the morning time, the position information moves along the subway line, and the speed of the user device is equal to the speed of the subway through the inertia information, the user situation may be derived as going to the work. As another example, when the time information is the evening time, the position information is a gym, and the inertia information indicates a regularly repeated motion, the user situation may be derived from taking exercise in the gym.

Next, the user sentiment which is a sentiment felt by the user at the time of listening to the music is derived from user sentiment data of the user data. The user sentiment data includes at least one of user's biometric signal information and user device operation information. For example, a sentiment felt by the user at the time of listening to the music may be derived through the biometric signal information such as pulse, emission of sweat, etc., or the user sentiment for the music may be derived through the user's device operation information which is information input to the user device by the user when listening to the music. Therefore, the user sentiment may be derived based on the user sentiment data.

When the music emotion, the user situation and the user sentiment are derived, the music emotion, the user situation and the user sentiment are mutually mapped to the three-dimensional graph, as illustrated in FIG. 2, to generate a music preference profile.

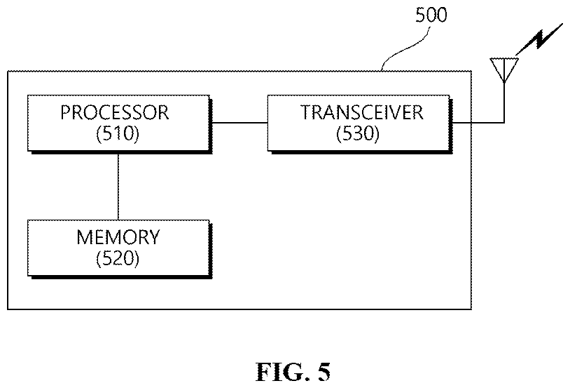

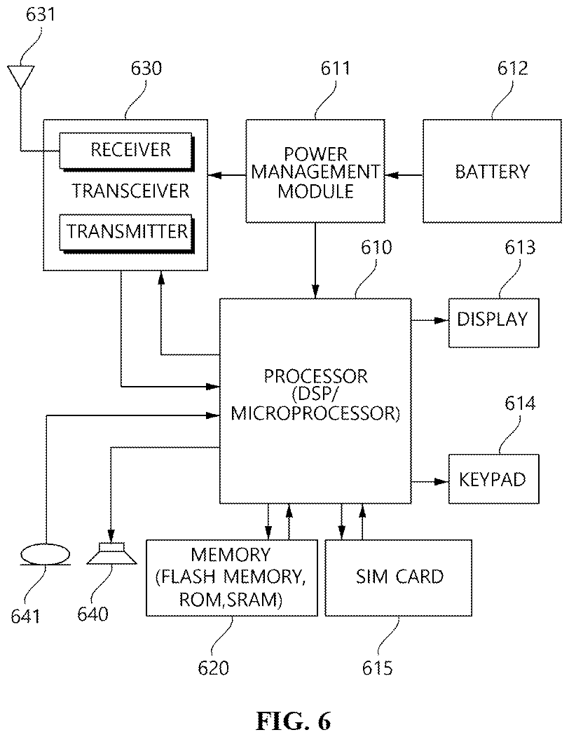

FIGS. 5 to 6 are diagrams illustrating a content recommendation device implemented in the moving means according to an exemplary embodiment of the present invention.

Referring to FIG. 5, a content recommendation device 500 may include a processor 510, a memory 520, and a transceiver 530. The processor 510 may be configured to implement a function, a process, and/or a method described in the present specification. Layers of a wireless interface protocol may be implemented by the processor 510.

The memory 520 is operably coupled with the processor 510 to store various pieces of information for operating the processor 510. The transceiver 530 is operably coupled with the processor 510 to transmit and/or receive a radio signal.

The processor 510 may include an application-specific integrated circuit (ASIC), other chipsets, a logic circuit, and/or a data processing apparatus. The memory 520 may include a read-only memory (ROM), a random access memory (RAM), a flash memory, a memory card, a storage medium, and/or other storage devices. The transceiver 530 may include a baseband circuit for processing a radio frequency signal. When an embodiment is implemented in software, the techniques described herein may be implemented in a module (e.g., procedures, functions, etc.) that performs the functions described herein. The module may be stored in the memory 520 and may be executed by the processor 510. The memory 520 may be implemented inside the processor 510. Alternatively, the memory 520 may be implemented outside the processor 510 and may be communicatively connected to the processor 510 through various means blown in the art.

Referring to FIG. 6, a content recommendation device 600 includes a processor 610, a power management module 611, a battery 612, a display 613, a keypad 614, a subscriber identification module (SIM) card 615, a memory 620, a transceiver 630, one or more antennas 631, a speaker 640, and a microphone 641.

The processor 610 may be configured to implement a function, a process, and/or a method described in the present specification. Layers of a wireless interface protocol may be implemented by the processor 610. The processor 610 may include an application-specific integrated circuit (ASIC), other chipsets, a logic circuit, and/or a data processing apparatus. The processor may be an application processor (AP). The processor 610 may include at least one of a digital signal processor (DSP), a central processing unit (CPU), a graphics processing unit (GPU), and a modulator and demodulator (Modem).

The power management module 611 manages power for the processor 610 and/or the transceiver 630. The battery 612 supplies the power to the power management module 611. The display 613 outputs a result processed by the processor 610. The keypad 614 receives an input to be used by the processor 610. The keypad 614 may be displayed on the display 613. The SIM card 615 is an integrated circuit used to safely store an international mobile subscriber identity (IMSI) used to identify and authenticate a subscriber on a mobile phone device, such as a mobile phone and a computer, and associated keys thereof. Contact habituation may also be stored in many SIM cards.

The memory 620 is operably coupled with the processor 610 to store various pieces of information for operating the processor 610. The memory 620 may include a read-only memory (ROM), a random access memory (RAM), a flash memory, a memory card, a storage medium, anchor other storage devices. When an embodiment is implemented in software, the techniques described herein may be implemented in a module (e.g., procedures, functions, etc.) that performs the functions described herein. The module may be stored in the memory 620 and may be executed by the processor 610. The memory 620 may be implemented inside the processor 610. Alternatively, the memory 620 may be implemented outside the processor 610 and may be communicatively connected to the processor 610 through various means known in the art.

The transceiver 630 is operably coupled with the processor 610 to transmit anchor receive a radio signal. The transceiver 630 includes a transmitter and a receiver. The transceiver 630 may include a baseband circuit for processing a radio frequency signal.

The transceiver controls one or more antennas 631 to transmit and/or receive radio signals.

The speaker 640 outputs a sound-related result processed by the processor 610. The microphone 641 receives a sound-related input to be used by the processor 610.

The content recommendation device may be implemented in a conveying means, and may include a communication unit, a camera unit, a position information unit, a sensor unit, an audio unit, an input unit, a display unit, a storage unit, a control unit, and the like.

The communication at it is a means for communication between the content recommendation devices or communication with the server. The communication unit may communicate with other user devices using a communication method such as near field communication (NFC), Bluetooth, ZigBee, and infrared data association (IrDA). The communication unit may communicate with the server via a network. The communication unit may include a radio frequency (RF) transmitter Tx up-converting and amplifying a frequency of a signal to be transmitted and an RF receiver Rx low-noise amplifying a signal to be received and down-converting the frequency. Further, the communication unit may include a modem that modulates the transmitted signal and demodulates the received signal. The communication unit receives data transmitted from the control unit, for example, user data to transmit the data to the server through the network. In addition, the communication unit transmits the received message, for example, recommended music to the control unit.

The camera unit is to photograph an image, and includes at least an image sensor. The image sensor receives light reflected by a subject and converts the received light into an electrical signal, and may be implemented based on a charged coupled device (CCD), a complementary metal-oxide semiconductor (CMOS), and the like. The camera unit may further include an analog to digital converter and convert an analogue signal output from the image sensor into a digital signal to output the converted analogue signal to the control unit.

The position information unit is for receiving a GPS signal. For example, the position information unit continuously receives the GPS signal from a GPS satellite and the like, and derives position information from the received GPS signal. The derived position information is transmitted to the control unit. Such position information may be coordinated such as a latitude, a longitude, and an altitude.

The sensor unit collects a plurality of different user data through a plurality of different sensors. Such a sensor may be implemented as micro electro-mechanical systems (MEMS). The sensor unit may include at least one inertia sensor such as an accelerometer, a gyroscope, and the like. The sensor unit may detect inertia information such as an acceleration and a displacement, as well as a movement speed of the user. device through the inertia sensor. Further, the sensor unit includes at least one biological signal sensor for collecting a user's biometric signal. For example, the sensor unit may include a biometric signal sensor such as a heart rate sensor which measures the heart rate of the user through a blood flow observed in the vessel of a user's wrist, and a sweat sensor which measures sweat and the like sensed in a portion of wearing the user device in the case of a wearable device or in a hand part where the user grips the user device in the case of a hand-held device. The sensor unit provides user data including the sensed inertia information or biometric signal information to the control unit.

The audio unit includes a microphone MIC and a speaker SPK. The audio unit receives the user's voice through the microphone MIC and provides the input voice to the control unit. In addition, the audio unit outputs music provided from the control unit through the speaker SPK.

The input unit receives a key operation of the user for controlling the user device and generates an input signal to transmit the generated input signal to the control unit. The input unit may include various types of keys for controlling the user device. When the display unit is formed of a touch screen, the functions of various types of keys may be performed on the display unit, and when all functions may be performed with only the touch screen, the input unit may also be omitted.

The display unit visually provides the menu, input data, function setting information, and other various information of the user device to a user. The display unit performs a function of outputting a screen such as a booting screen, a standby screen a menu screen, and the like of the user device. Such a display unit may be formed of a liquid crystal display (LCD), organic hot emitting diodes (OLEDs), active matrix organic light emitting diodes (AMOLEDs), and the like. On the other hand, the display unit may be implemented as a touch screen. In this case, the display unit includes touch sensor. The touch sensor detects the user's touch input. The touch sensor may be configured as a touch sensor such as a capacitive overlay, a pressure type, a resistive overlay, an infrared beam or a pressure sensor. In addition to the sensors, all kinds of sensor devices capable of sensing the contact or pressure of an object may be used as the touch sensor of the present invention. The touch sensor senses a user's touch input and generates a sensing signal to transmit the generated sensing signal to the control unit. Particularly, when the display unit is formed of the touch screen, some or all of the functions of the input unit may be made through the display unit.

The storage unit serves to store programs and data required for the operation of the user device. In particular, the storage unit may store music files, applications for music reproduction, and the like. Various kinds of data stored in the storage unit may be deleted, changed, and added depending on the user's operation.

The control unit controls an overall operation of the user device and a signal flow between internal blocks of the user device and may perform a data processing function for processing data. In addition, the control unit basically selves to control various types of functions of the user device. The control unit may illustrate a central processing unit (CPU), a digital signal processor (DSP), and the like. The control unit collects user data through at least one of the position information unit, the sensor unit, the audio unit, the input unit, and the display unit, and transmits the user data collected through the communication unit to the server, when the music is reproduced. Then, the recommendation server will generate a preferred music profile. In addition, the control unit collects user data through at least one of the position information unit, the sensor unit, the audio unit, the input unit, and the display unit, and transmits the user data collected through the communication unit to the recommendation server, when the recommendation music is requested. Then, the recommendation server will derive recommendation music through the preferred music profile. The control unit receives the recommendation music derived by the recommendation server through the communication unit, and may reproduce the received music. The operation of the control unit will be described in more detail below.

The corresponding technology is applied to a connected car which is a major industry in the region to contribute to position-based services, personalized services, and an increase in driver's pleasures and contribute to a local industry ecosystem that win-wins through the linkage with the major industry. For example, main moving positions (house, office, etc.), weather, movement speed (exercise, drive, etc.), seasons, an exceptional situation, etc. are determined through learning of GPS sensor information, Wifi (SSID), Bluetooth sensor values to analyze a context of ‘a situation where the user go to take exercise around the lake in a sunny day’ and provide preferred music (music good for warming-up among user's preferred music) suitable for a user's situation by deriving the analyzed context to a situation recognition value.

Economic subjects are using a lot of time on the road, but may minimize an unproductive time waste to select the content through a personalized content system according to vehicle environment information. Further, it is possible to relieve stress due to driving through content recommendation according to the situation, and provide a healing and therapeutic effect.

In addition, various derivative services may be linked through situation-based content recommendation.

That is, it is possible to be used to the processing of real-time data generated in a smart car such as a connected car and a technology on cloud server interworking. Meanwhile, it is possible to be used for determination of a user situation and a real-time dynamic situation and advertisements, safety information, healthcare, and content recommendation according thereto. Further, it is possible to be used for music and broadcast recommendation that combines user situation and sentiment.

A service for drivers through situation analysis may be provided with real-time road information, navigation, a parking auxiliary system, weather information, and an eco-friendly driving service. On the other hand, as a connected car service for passengers, situation-based streaming music, video, situation analysis guide service, weather information, situation-based social media automatic input software, situation analysis-based application access may also be provided. In addition, as a connected car service for vehicles, pre-maintenance/diagnosis through user situation analysis, situation analysis-based vehicle tracking, situation analysis-based insurance tracking, eCall, and emergency services may also be provided.

The moving means may provide a service based on an autonomous driving platform, and may provide a composite service combined with delivery, healthcare, and content recommendation.

For example, a delivery autonomous driving robot may deliver necessary articles to vulnerable social groups or old people living alone, periodically analyze their situations, and provide one-site real-time medical examination and healthcare information.

An autonomous driving robot for healthcare autonomous driving robot advertisement capable of remote care, and a local-based advertisement service may be provided. Obstacle avoidance using infrared rays and LiDAR, and real-time face blur processing may be provided. An autonomous driving robot that helps to carry the luggage in the vehicle tracks the driver and avoids obstacles immediately after the vehicle stop, and an autonomous driving robot returning to the vehicle after the destination arrival may be provided. A robot which autonomously drives in apartments and processes luggage carrying, a garbage separation collection, etc. may be provided. An autonomous driving robot may be provided fix autonomously driving in hotels and providing concierge services. An autonomous driving robot may be provided to analyze a densely populated area while searching a local advertisement periphery and provide advertisement to the corresponding advertiser.

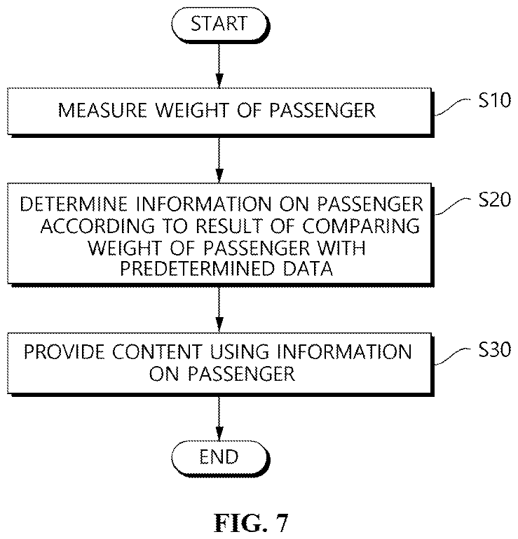

FIG. 7 is a flowchart illustrating a method for a content recommendation streaming service according to another exemplary embodiment of the present invention.

A content recommendation streaming service method of a moving means mounted with a sensor includes measuring the weight of a passenger (S10), determining passenger information according to a result of comparing the weight of the passenger with predetermined data (S20) and providing a content by using the passenger information (S30).

The determining of the passenger information (S20) may determine the arrangement of seats, the presence of passengers, the number of passengers, and whether some of the passengers are infants.

The determining of the passenger information (S20) may check whether the infants board by considering a seat position where a car seat is installed and a weight change of the car seat.

The providing of the content (S30) may receive the feedback of the crying sound of the infants to recommend a content or control a volume of a speaker corresponding to the position of the car seat using artificial intelligence.

The providing of the content (S30) may check the visit of a rest area through the sensor and recommend travel music that considers the preference for the remaining passengers during the visit of the rest area using artificial intelligence.

The providing of the content (S30) may check the scenery through the sensor, sense actions in which some passengers temporarily get off or lower a window while the moving means is temporarily stopped in order for the passengers to see the scenery, and change a music mode or control the volume according to the scenery using artificial intelligence.

The devices according to the embodiment may be mounted in a form of software, hardware, or a combination type thereof in a computing device or server having hardware components. The computing device or server may mean various devices which include all or some of a communication device such as a communication modem for performing communication with various devices or wired/wireless communication networks, a memory for storing data for executing a program, a microprocessor for performing a computation and commanding by executing a program.

In FIG. 7, it is disclosed that the respective processes are sequentially executed, but this is just an exemplary description and those skilled in the art will be able to make various modifications and transformations and apply the modifications and transformations by executing the processes by changing an order disclosed in FIG. 7, executing one or more steps in parallel, or adding other processes without departing from an essential characteristic of the exemplary embodiment of the present invention.

The operations according to the exemplary embodiments are implemented in a form of a program command which may be performed through various computer meal and may be recorded in the computer readable medium. The computer readable medium represents any medium that participates in providing instructions to a processor for execution. The computer readable medium may include a program command, a data file, or a data structure or a combination thereof For example, the computer readable medium may include a magnetic medium, an optical recording medium, a memory, and the like. A computer program may be distributed on a networked computer system so that a computer readable code may be stored and executed in a distributed manner. Functional programs, codes, and code segments for implementing the exemplary embodiment may be easily inferred by programmers in the art to which the exemplary embodiment belongs.

Meanwhile, the embodiments according to the present invention may be implemented in the form of program instructions that may be executed by computers and may be recorded in computer readable media. The computer readable media, may include program instructions, a data file, a data structure, or a combination thereof. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information, and which may accessed by computer.

Communication media typically embodies computer readable instructions, data structures, program modules or other data in a modulated data signal such as a carrier wave or other transport mechanism and includes any information delivery media. The term “modulated data, signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A method for a content recommendation streaming service of a moving means mounted with sensors, comprising the steps of:
measuring a weight of a passenger;
determining information on the passenger according to a result of comparing the weight of the passenger with predetermined data; and
providing a content by using the information on the passenger.

2. The method for the content recommendation streaming service of claim wherein the determining of the passenger information is to determine the arrangement of seats, a presence of the passengers, the number of the passengers, and whether some of the passengers are infants.

3. The method for the content recommendation streaming service of claim 2, wherein the determining of the passenger information is to check Whether the infants board by considering a seat position where a car seat is installed and a weight change of the car seat.

4. The method for the content recommendation streaming service of claim 3, Wherein the providing of the content is to receive a feedback of a crying sound of the infants to recommend a content or control a volume of a speaker corresponding to the position of the car seat using artificial intelligence.

5. The method for the content recommendation streaming service of claim 1, wherein the providing of the content is to check a visit of a rest area through the sensor and recommend travel music that considers a preference for remaining passengers during the visit of the rest area using artificial intelligence.

6. The method for the content recommendation streaming service of claim 1, Wherein the providing of the content is to check a scenery through a sensor, sense actions in which some passengers temporarily get off or lower a window while the moving means is temporarily stopped in order for the passengers to see the scenery and change a music mode or control a volume according to the scenery using artificial intelligence.

7. A moving means, comprising:
a sensor which is installed in a seat to measure the weight of a passenger;
a processing unit which determines information on the passenger according to a result of comparing the weight of the passenger with predetermined data; and
an output unit which provides a content by using the information on the passenger.

8. The moving means of claim 7, wherein the processing unit determines the arrangement of seats, a presence of the passengers, the number of the passengers, and Whether some of the passengers are infants.

9. The moving means of claim 8, wherein the processing unit checks whether the infants board by considering a seat position where a car seat is installed and a weight change of the car seat.

10. The moving means of claim 9, wherein a voice sensing device that receives a feedback of a crying sound of the infants is included, and
the output unit recommends a content or control a volume of a speaker corresponding to the position of the car seat using artificial intelligence based on the crying sound.

11. The moving means of claim 7, wherein a navigation to search a peripheral environment of the moving means is included, and
the processing unit checks a visit of a rest area through a position of the moving means,
the sensor determines the get-off of some passengers, and
the output unit recommends travel music that considers a preference for remaining passengers during the visit of the rest area using artificial intelligence.

12. The moving means of claim 7, wherein the sensor includes an image sensor which is installed inside or outside of the moving means to photograph the internal or external sides of the moving means,
the image sensor checks a scenery,
the processing unit senses actions in which some passengers temporarily get off or lower a window while the moving means is temporarily stopped in order for the passengers to see the scenery, and
the output unit outputs music changed according to the scenery or control a volume using artificial intelligence.
